(19) United States
(12) Patent Application Publication
(10) Pub. No.: US 2005/0218556 A1
(43) Pub. Date: Oct. 6, 2005

(54) Method and apparatus for spray forming polyurethane skins with a hydraulic mixing head

(75) Inventors: Joseph T. Donatti, Howell, MI (US); Andrew P. Mellentine, Owosso, MI (US); Nelson E. Williams JR., Saline, MI (US); Ian S. Williams, Howell, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/817,025

(22) Filed: Apr. 2, 2004

(51) Int. Cl. B29C 31/00

(52) U.S. Cl. 264/240; 264/328.2; 425/103

(57) ABSTRACT

An apparatus for spraying polyurethane to form a skin on a mold. Polyurethane forming constituents are provided from a plurality of separate supply sources to separate recirculating fluid circuits. A mix head receives polyurethane constituents from the fluid circuits and mixes them to form a polyurethane mixture. A hydraulically operated valve controls the flow of the polyurethane constituents. The valve has a first position in which the polyurethane components are permitted to flow into the chamber of the mix head. The polyurethane mixture is then dispensed through a spray nozzle assembly. When the valve is in a second position, the polyurethane constituents are recirculated through the fluid circuits. A liquid solvent may be injected into the mix head under pressure to purge the mixture from the mix head and spray nozzle assembly in the second position.

### BACKGROUND OF THE INVENTION

1. Field of the Invention

The present invention relates to an apparatus and method for spray forming a polyurethane skin to be used in manufacturing a vehicle interior component.

2. Background Art

For many years, vehicle interior parts have been formed by providing a skin formed in the shape of the interior part that is filled with foam material and may also be assembled to a structural member. Vinyl skins are formed in rotocasting operations in which liquid vinyl is poured into a closed, heated mold that is rotated to coat the mold with the vinyl composition. The vinyl composition cures as a hollow skin conforming to the mold surface. While this process has been used to form high quality parts, considerations relating to the difficulty of recycling vinyl parts and minimizing volatile organic compositions in vehicle interiors is causing original equipment manufacturers to reduce the use of vinyl parts in vehicle interiors. Polyurethane skins are being developed to replace vinyl skins in interior components. Polyurethane materials reduce the quantity of volatile organic compositions in interior parts. Rotocasting polyurethane is not favored because thermoplastic polyurethane materials that may be used are very expensive aliphatic materials.

Prior art polyurethane spray systems rely upon pneumatic mixing heads that are subject to many disadvantages and limitations. Such mixing heads are generally designed to handle two chemical components. Pneumatic mixing heads tend to malfunction when spraying higher viscosity materials. Pneumatic mixing heads may be adversely affected by the quality and quantity of compressed air that is available. Pneumatic mixing heads do not recirculate through the mix head, but through a recirculation block mounted above the mixing head. Pneumatic mixing heads are not normally capable of maintaining polyurethane constituents at the desired temperature for spray forming polyurethane skins on a mold.

There is a need for a robust mixing head that is well adapted to dispensing high viscosity polyurethane components and mixtures.

There is also a need for a mixing head that provides a more uniform spray pattern and that does not rely on external screw adjustments to seat the injection pin in an orifice.

There is a further need for a recirculation circuit that facilitates maintaining the temperature of heated polyurethane forming constituents as the material recirculates until it is introduced into the spray tool mixing head.

There is a need for a mixing head for mixing polyol and isocyanate with a pigmented polyurethane forming component.

The above problems are addressed and needs are fulfilled by Applicants' invention as summarized below.

### SUMMARY OF THE INVENTION

According to one aspect of the present invention, an apparatus for spraying polyurethane is provided. The apparatus includes a plurality of supply sources containing one of a plurality of polyurethane constituents. A plurality of recirculating fluid circuits are each in fluid flow communication with one of the supply sources. A mix head is connected to each of the fluid circuits and receives from each fluid circuit one of the polyurethane constituents. The mix head has a chamber in which the polyurethane constituents are mixed to form a polyurethane mixture. A hydraulically operated valve controls the flow of polyurethane constituents to the mix head. The valve has a first position in which the polyurethane constituents flow into a mixing chamber in the mix head, and a second position in which the polyurethane constituents are recirculated through the fluid circuit without being mixed in the mixing chamber. A spray nozzle assembly dispenses the polyurethane mixture when the valve is in the first position.

According to other aspects of the apparatus of the present invention, the polyurethane constituents may be polyol, isocyanate, and pigmented polyol that are provided by separate recirculating fluid circuits. The recirculating fluid circuits may each have a separate pump for providing one of the polyurethane constituents under pressure. A liquid solvent may be supplied to the mix head to purge the polyurethane mixture from the chamber in the mix head and the spray gun when the valve is in the second position.

According to other aspects of the apparatus of the present invention, the hydraulically operated valve may have a hydraulically actuated piston that is provided with separate channels through which each of the polyurethane constituents flow when the valve is in the second position. The hydraulically operated valve may be operated by a hydraulic fluid circuit that has a reciprocating piston that shifts the valve between the first and second positions. The reciprocating piston shifts a valve spool within an elongated chamber. The valve spool and chamber are sealed relative to each other as the valve spool moves between the first and second positions. A seal may be secured to the valve spool to assure that a seal is established between the spool and chamber.

According to other aspects of the apparatus of the present invention, the spray gun may have a tubular portion and a static helical mixing vane disposed in the tubular portion that mixes the polyurethane mixture as it is dispensed. The mixture of polyurethane may be sprayed by the spray nozzle assembly on a mold to form a polyurethane skin for a vehicle interior part.

Another aspect of the present invention relates to the method that is used to form a polyurethane skin for an interior part of the vehicle. The method comprises pumping an isocyanate composition and polyol composition to the mix head. A valve is selectively opened in a first position to allow the polyol composition and isocyanate composition to be injected under pressure into a mixing chamber defined by the mix head to create a polyurethane reactant mixture. The valve is selectively closed in a second position to allow the polyol composition and isocyanate composition to be recirculated. The valve is moved by a hydraulically actuated cylinder that moves a valve element within a valve body between the first and second positions. The polyurethane reactant mixture is dispensed through a spray nozzle assembly and shaped on a mold surface to form a polyurethane skin.

An alternative embodiment of the method may be practiced wherein a pigmented polyol composition is pumped to the mix head in addition to the isocyanate and polyol constituents as described above. The three constituents are injected in a first position into the mix head under pressure to create a pigmented polyurethane reactant mixture. The valve may be selectively closed in a second position to recirculate the three constituents. The pigmented polyurethane reactant mixture is dispensed through a spray nozzle assembly and shaped on a mold surface to form the polyurethane skin with the desired pigmentation.

Other aspects of the invention as they relate to the above methods may further comprise mixing the reactants with a static helical mixing vane disposed in a tubular portion of the spray nozzle assembly. The method may further comprise spraying a solvent into the mixing chamber when the valve is in the second position to purge the polyurethane reactant mixture from the mixing chamber and spray nozzle assembly. The valve element used in the method may further comprise a piston that is provided with separate channels for each of the reactant compositions when the valve is in the second position.

These and other aspects of the invention will be better understood in view of the attached drawings and following detailed description and preferred embodiments of the invention.

### BRIEF DESCRIPTION OF THE DRAWINGS

FIG. 1 is a perspective view of a spray tool apparatus for spraying polyurethane made according to the present invention;

FIG. 2 is a longitudinal cross-sectional view of the spray tool apparatus in a first position;

FIG. 3 is a longitudinal cross-sectional view of the spray tool apparatus in a second position;

FIG. 4 is a perspective view of a valve piston for the spray tool apparatus;

FIG. 5 is a cross-sectional view taken along the line 5-5 in FIG. 4;

FIG. 6 is a diagrammatic cross-sectional view showing the valve piston in its recycling position; and

FIG. 7 is a transverse cross-section of an alternative embodiment of the valve piston that may be used to spray three components to form a colored polyurethane mixture.

### DETAILED DESCRIPTION OF THE PREFERRED EMBODIMENT(S)

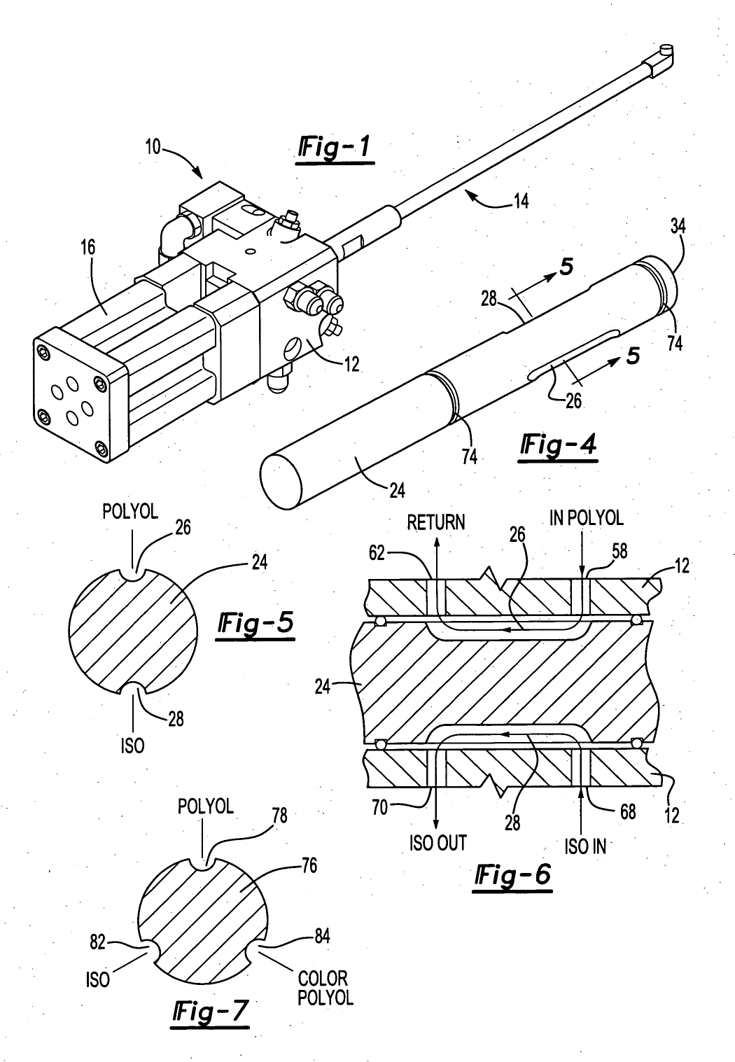

Referring to FIG. 1, a spray tool apparatus 10 is shown to include a mix head 12 that is connected to a nozzle assembly 14. The mix head 12 is operated by means of a hydraulic actuator 16. The spray tool apparatus 10 is used to form a polyurethane skin by mixing and spraying polyurethane constituents through the nozzle assembly 14.

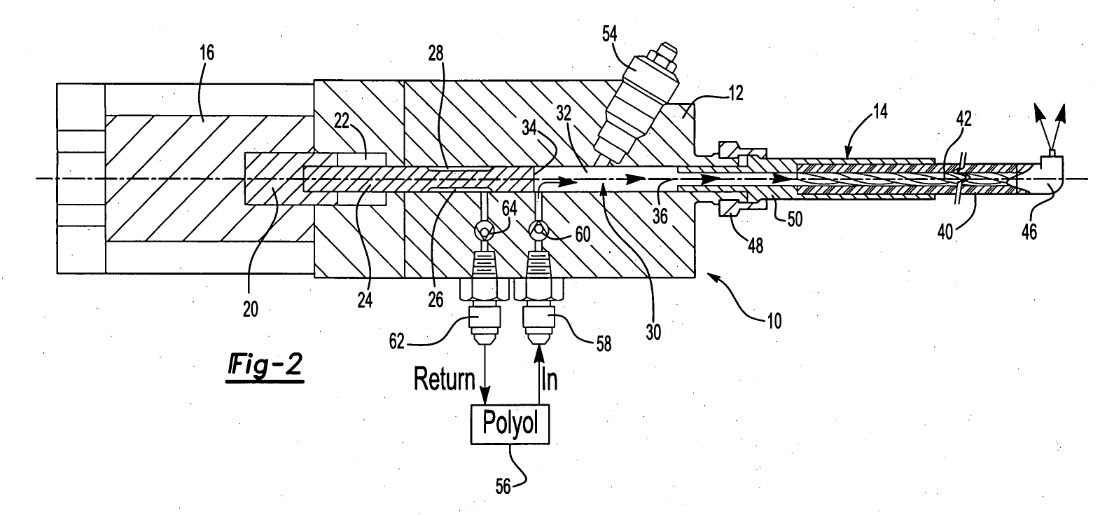

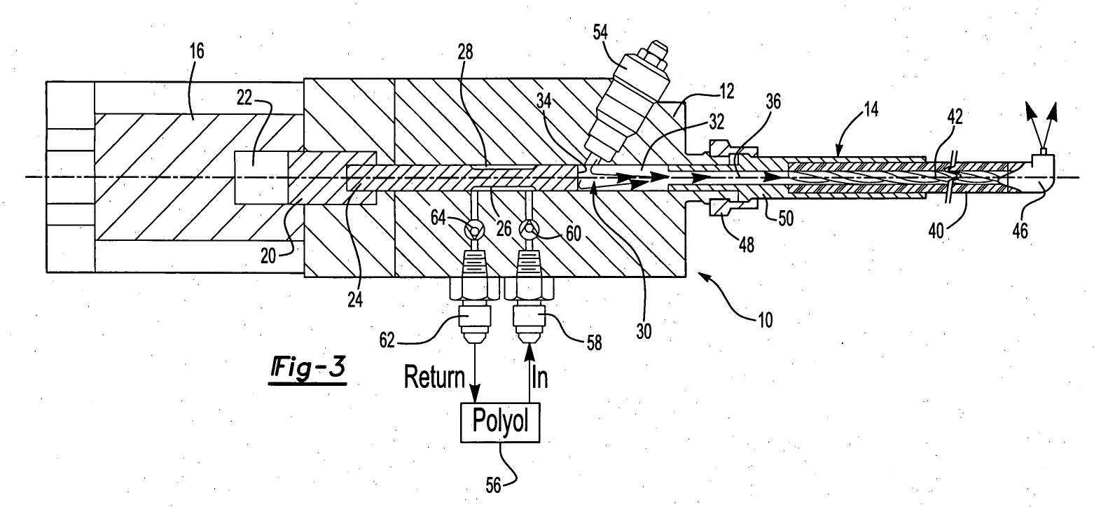

Referring to FIGS. 2 and 3, the spray tool apparatus 10 is shown in cross-section to illustrate the functional relationship of the mix head 12, nozzle assembly 14 and hydraulic actuator 16. A hydraulic piston 20 is disposed in a chamber 22 for moving a valve piston 24 between a first position shown in FIG. 2 and a second position shown in FIG. 3. Valve piston 24 in the illustrated embodiment has a first channel 26 and a second channel 28 formed on the sides of the valve piston 24.

A mixing chamber generally indicated by reference numeral 30 comprises a cavity 32 that is closed on one end by a distal end 34 of the valve piston 24. The mixing chamber 30 has an outlet 36 on the opposite end from the distal end 34 of the valve piston 24 through which a polyurethane mixture may be sprayed as illustrated by the series of arrows in FIG. 2 leading to and through the nozzle assembly 14.

The nozzle assembly 14 includes a tubular extension 40. A helical mixing vane 42 is provided in the tubular extension 40. Polyurethane constituents flowing through the tubular extension 40 are mixed by the helical mixing vane 42 and are provided to a nozzle tip 46. The nozzle assembly 14 is detachably secured to the mix head 12 by an annular retainer ring 48 that engages a tube receptacle 50. Tube receptacle 50 receives the tubular extension 40 and retains it in a fluid flow relationship with the mixing chamber 30.

Referring to FIG. 3, a solvent flush injector 54 is shown spraying a solvent such as methylethylkeytone (MEK) into the mixing chamber 30 to flush and clear polyurethane constituents and the polyurethane mixture from the mixing chamber 30, tubular extension 40, and helical mixing vane 42. The solvent is purged through the nozzle tip 46 to clear the spray tool apparatus 10.

A polyol supply 56 is illustrated in FIGS. 2 and 3 that provides polyol to polyol inlet port 58. Polyol inlet port 58 may include a check valve 60 that permits polyol to flow in one direction into the mixing chamber. A polyol outlet port 62 receives polyol from the first channel 26 when the valve piston 24 is in the second position as shown in FIG. 3. The polyol outlet port 62 is provided with a check valve 64 that normally permits polyol to flow in one direction out of the spray tool apparatus and return to the polyol supply 56. The spray tool apparatus 10 is shown in its recycling mode in FIG. 3 that will be more fully described with reference to FIGS. 4-6 below.

Referring now to FIGS. 4-6, the valve piston 24 is shown to include first and second channels 26 and 28. First and second channels 26 and 28 are shown, for example, to be diametrically opposed on opposite sides of the valve piston 24. The first and second channels 26 and 28 provide for recycling of the polyol as previously described and also provide for recycling of isocyanate that is provided through an isocyanate port 68 and is recirculated through isocyanate outlet port 70. When the valve piston 24 of the spray tool apparatus 10 is in a position shown in FIG. 3, polyol and isocyanate are recycled through the first and second channels 26 and 28 that keep the polyol forming constituents moving and heated to a desired temperature. When the valve piston 24 of the spray tool apparatus 10 is in the first position that is shown in FIG. 2, isocyanate and polyol are mixed in the mixing chamber 30 and dispensed through the nozzle assembly 14 and through the nozzle tip 46.

Seals 72, that may be O-ring seals, are retained in annular grooves 74 formed on the valve piston 24 outboard of opposite axial ends of the channels 26 and 28.

Referring to FIG. 7, an alternative embodiment of the valve piston 76 is shown that may be used to mix a three component mixture comprising isocyanate, polyol, and colored or pigmented polyol. The spray tool apparatus shown in FIG. 1 would be provided with three sets of inlet and outlet ports for each of the constituents as previously described. The alternate valve piston 76 has a first channel 78 for the polyol, a second channel 80 for isocyanate, and a third channel 84 for colored, or pigmented, polyol. In this embodiment, operation and function of the spray tool apparatus 10 is substantially the same except that three different constituents are provided to the mix chamber in the first position shown in FIG. 2. Three separate flow paths are provided in the recirculating mode so that polyol, isocyanate and pigmented polyol may be separately recirculated in a manner similar to the two component recirculation system described above.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A spray tool apparatus for spraying polyurethane, comprising:
a plurality of supply sources, each supply source containing one of a plurality polyurethane constituents;
a plurality of recirculating fluid circuits each in fluid flow communication with one of the supply sources for distributing one of the polyurethane constituents;
a mix head connected to each of the fluid circuits that receives from each fluid circuit one of the polyurethane constituents, the mix head having a chamber in which the plurality of polyurethane constituents are mixed to form a polyurethane mixture;
a hydraulically operated valve for controlling the flow of the polyurethane constituents to the mix head, the valve having a first position in which the polyurethane constituents flow into the chamber of the mix head and a second position in which the polyurethane constituents are recirculated through the fluid circuits without being mixed in the mixing chamber; and
a spray nozzle assembly through which the polyurethane mixture is dispensed when the valve is in the first position.

2. The apparatus of claim 1 wherein the polyurethane constituents are polyol, isocyanate, and pigmented polyol.

3. The apparatus of claim 1 wherein the recirculating fluid circuits each have a separate pump for pressurizing one of the polyurethane constituents.

4. The apparatus of claim 1 further comprising a liquid solvent supplied to the mix head under pressure to purge the polyurethane mixture from the chamber in the mix head and the spray nozzle assembly when the valve is in the second position.

5. The apparatus of claim 1 wherein the hydraulically operated valve has a hydraulically actuated piston that is provided with separate channels for each of the polyurethane constituents through which the constituents flow when the valve is in the second position.

6. The apparatus of claim 1 wherein the hydraulically actuated valve is operated by a hydraulic fluid circuit that has a reciprocating piston that shifts the valve between the first and second positions.

7. The apparatus of claim 1 wherein the hydraulically actuated valve is operated by a hydraulic fluid circuit that has a reciprocating piston that shifts a valve spool within an elongated chamber, the valve spool and chamber being sealed relative to each other as the valve spool moves between the first and second positions.

8. The apparatus of claim 7 further comprising a seal secured to the valve spool that seals against the chamber.

9. The apparatus of claim 1 wherein the spray nozzle assembly has a tubular portion and a static helical mixing vane disposed in the tubular portion that mixes the polyurethane mixture before the polyurethane mixture is dispensed through a nozzle tip.

10. The apparatus of claim 1 wherein the mixture of polyurethane is sprayed on a mold to form a polyurethane skin for a vehicle interior part.

11. A method of forming a polyurethane skin for an interior part of a vehicle, comprising:
pumping an isocyanate composition to a mix head;
pumping a polyol composition to the mix head;
opening a valve selectively to allow the polyol composition and the isocyanate composition to be injected under pressure into a mixing chamber defined by the mix head in a first position to create a polyurethane reactant mixture;
closing the valve selectively to allow the polyol composition and isocyanate composition to be recirculated through the valve in a second position;
moving the valve with a hydraulically actuated cylinder that moves a valve element within a valve body between the first position and the second position;
dispensing the polyurethane reactant mixture through a spray nozzle; and
shaping the polyurethane reactant mixture on a mold surface to form a polyurethane skin.

12. The method of claim 11 further comprising mixing the polyurethane reactant mixture with a static helical mixing vane disposed in a tubular portion of the spray nozzle.

13. The method of claim 11 further comprising spraying a solvent into the mixing chamber when the valve is in the second position to purge the polyurethane reactant mixture from the mixing chamber and the spray nozzle.

14. The method of claim 11 wherein the valve element further comprises a piston that is provided with a first separate channel for the isocyanate composition and a second separate channel for the polyol composition, wherein each of the compositions flow through one of the separate channels when the valve is in the second position.

15. A method of forming a polyurethane skin for an interior part of a vehicle, comprising:
pumping an isocyanate composition to a mix head;
pumping a polyol composition to the mix head;
pumping a pigmented polyol composition to the mix head;
opening a valve selectively to allow the polyol composition, the isocyanate composition, and the pigmented polyol to be injected under pressure into a mixing chamber defined by the mix head in a first position to create a pigmented polyurethane reactant mixture;
closing the valve selectively to allow the polyol composition, isocyanate composition, and the pigmented polyol to be recirculated in a second position;
moving the valve with a hydraulically actuated cylinder that moves a valve element within a valve body between the first position and the second position;
dispensing the pigmented polyurethane reactant mixture through a spray nozzle; and
shaping the pigmented polyurethane reactant mixture on a mold surface to form a polyurethane skin.

16. The method of claim 15 further comprising mixing the pigmented polyurethane reactant mixture with a static helical mixing vane disposed in a tubular portion of the spray nozzle.

17. The method of claim 15 further comprising spraying a solvent into the mixing chamber when the valve is in the second position to purge the pigmented polyurethane reactant mixture from the mixing chamber and the spray nozzle.

18. The method of claim 15 wherein the valve element further comprises a piston that is provided with a first separate channel for the isocyanate composition, a second separate channel for the polyol composition, and a third separate channel for the pigmented polyol composition, wherein each of the compositions flow through one of the separate channels when the valve is in the second position.
